(19) United States
(12) Patent Application Publication
(10) Pub. No.: US 2020/0047338 A1
(43) Pub. Date: Feb. 13, 2020

(54) METHOD AND APPARATUS FOR CONTROLLING A MACHINE BASED ON A DETECTION OF AN ABNORMALITY

(71) Applicant: MEIWA e-TEC Co., LTD., Toyota-shi (JP)

(72) Inventors: Hiroomi YAMADA, Toyota-shi (JP); Hirokazu KIDA, Toyota-shi (JP); Sakayuki ISHIKAWA, Toyota-shi (JP)

(21) Appl. No.: 16/058,066

(22) Filed: Aug. 8, 2018

(51) Int. Cl. B25J 9/16; G01D 5/00

(52) U.S. Cl. CPC B25J 9/1653; G01D 5/00

(57) ABSTRACT

An abnormality monitoring method capable of reliably detecting abnormality or an initiation of an abnormality of a monitored object includes: acquiring time series monitored data from a monitored object; calculating a wavelet transformed image from the monitored data; calculating a feature value at each point in the wavelet transformed image; and determining a presence or an absence of an abnormality of the monitored object based on the feature value. The feature value is a moment from a predetermined origin on a wavelet transformed image, and the presence or the absence of the abnormality of the monitored object is determined based on a Mahalanobis' Distance calculated from the feature value.

### CROSS-REFERENCE TO RELATED APPLICATIONS

The present application claims the benefit of U.S. Provisional Patent Application No. 62/715,360 filed Aug. 7, 2018, the entire contents of which is hereby incorporated by reference.

### BACKGROUND OF THE INVENTION

### Field of the Invention

The present invention relates to an abnormality monitoring method and to a method and apparatus for controlling a machine based on the detection of an abnormality and to an abnormality monitoring apparatus for determining the presence or absence of an abnormality in a monitored object such as a machine.

### Description of the Related Art

A monitored object such as a machine is provided with sensors for detecting events such as an operational abnormality of the monitored object. However, in abnormality sensing only by detecting whether a threshold is crossed by a detected signal obtained from each of the sensors due to a rapid increase or decrease in the signal, it is particularly difficult to predict an initiation of abnormality and take precautions.

Japanese Patent Laid-Open No. 2005-241089 proposes a monitoring system that uses, as feature value parameters of a plurality of waveform data obtained from a monitored object, a parameter that is based on time waveform data and a parameter that is based on frequency domain data, calculates a Mahalanobis' Distance based on the data, and detects an abnormality in the monitored object based on the resultant extent.

### SUMMARY OF THE INVENTION

The present disclosure aims to solve the above problem of the prior art, and an aspect of the present disclosure is to provide an abnormality monitoring method and an abnormality monitoring apparatus capable of reliably detecting abnormality or an initiation of abnormality of a monitored object and to provide a method and apparatus for controlling a monitored object such as a machine based on the detection of an abnormality.

An abnormality monitoring method of the present disclosure includes: acquiring time series monitored data from a monitored object; calculating a wavelet transformed image from the monitored data; calculating a feature value of the wavelet transformed image; and determining presence or absence of abnormality of the monitored object based on the feature value. Additionally, an abnormality monitoring apparatus of the present disclosure includes: means of acquiring time series monitored data from a monitored object; means of calculating a wavelet transformed image from the monitored data; and means of calculating a feature value of the wavelet transformed image and determining presence or absence of abnormality of the monitored object based on the feature value. Furthermore, a method and system according to the present disclosure include controlling the operation of a monitored object, such as a robot and/or a machine tool, for example, by stopping the operation of the robot and/or the machine, when the presence of an abnormality is detected.

In the above, the feature value may be a moment from a predetermined origin on a wavelet transformed image. Further, presence or absence of abnormality of the monitored object can be determined based on a Mahalanobis' Distance calculated from the feature value.

As described above, according to the abnormality monitoring method and the abnormality monitoring apparatus of the present invention, abnormality or an initiation of abnormality of the monitored object can reliably be detected.

### BRIEF DESCRIPTION OF THE DRAWINGS

FIG. 1 illustrates an entire configuration of an abnormality monitoring apparatus;

FIG. 2 is a flow chart illustrating a procedure of a learning process;

FIG. 3 is a flow chart illustrating a procedure of a feature value calculating process;

FIG. 4 is a flow chart illustrating a procedure of a process for determining abnormality of a monitored object in operation;

FIG. 5 illustrating an example of a waveform of monitored data; and

FIG. 6 illustrating an example of a wavelet transformed image.

### DETAILED DESCRIPTION OF THE PREFERRED EMBODIMENTS

It should be noted that the embodiment described below is only an example, and various design variations made by those skilled in the art are intended to fall within the scope of the present invention without departing from the gist of the present invention.

FIG. 1 illustrates an entire configuration of an abnormality monitoring apparatus for implementing a method of the present invention. In FIG. 1, a monitored object 1 such as an industrial robot and a machine tool is provided with sensors 11 such as vibration sensors, temperature sensors, accelerometers, sound sensors, voltage sensors, and position sensors to detect operational abnormality. Time series measured data (monitored data) 11a is input from the sensors 11 to a personal computer (PC) 2.

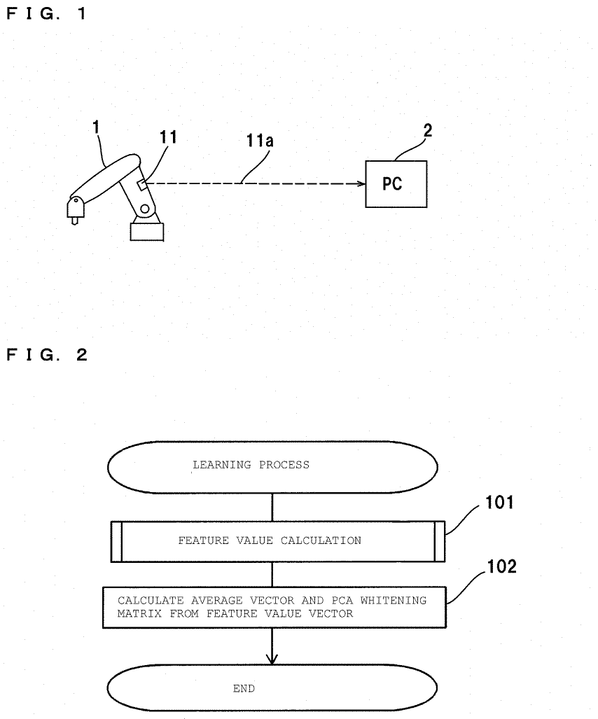

In the abnormality monitoring apparatus, a learning process is initially performed on the monitored data for one or more cycles during normal operation of the monitored object. The procedure of learning process is shown in FIG. 2. It should be noted that all the processes described below are implemented by a program executed on the PC.

In the learning process shown in FIG. 2, a feature value calculating process, which will be described later, is performed (step 101), followed by calculation of an average vector and a PCA whitening matrix from a feature value vector obtained by the previous process (step 102). The feature value calculating process is repeated on each monitored data as much as, for example, 100 times under various conditions.

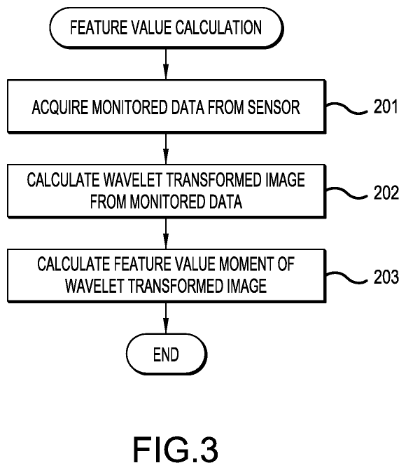

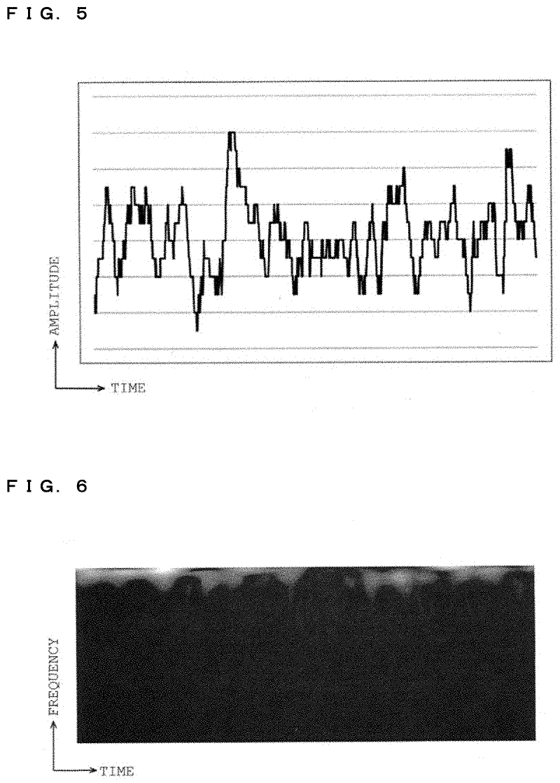

The details of the feature value calculating process are shown in FIG. 3. In step 201 of the feature value calculating process, time series monitored data, such as that shown in FIG. 5, is acquired from a sensor. The monitored data is subjected to a wavelet transformation to obtain a wavelet transformed image (step 202). In the embodiment, Gabor function is used for the wavelet transformation. An example of the wavelet transformed image is shown in FIG. 6, in which the axis of abscissas indicates time, the axis of ordinates indicates frequency, and the amplitude is represented by a difference in lightness (in reality, colorfulness or a difference in color). In step 203, a feature value moment muₙₘ is calculated for the wavelet transformed image. The feature value moment muₙₘ is two-dimensional in the embodiment and can be calculated with the formula (1) below.

muₙₘ=∫∫(x−x₀)ⁿ(y−y₀)^{m}f(x,y)dxdy (1)

In the formula, “n” and “m” are moment orders and from zero order to third order. “f” indicates a luminance value, “x” and “y” are image coordinates, and x₀ and y₀ are origin coordinates, and consideration is made to the case in which the origin coordinates are provided at two locations in the image: upper left and bottom right. Accordingly, 19 feature value moments can be obtained for each image. In the embodiment, since 100 images are obtained for each monitored data, which means that there are 19 feature value moments for each image, a feature value vector including them as its elements can be obtained.

Once the feature value calculating process described above is done, an average vector μ is calculated from the feature value moments as described in step 102 for FIG. 2 and a PCA whitening matrix ΛU is calculated. The average vector μ is a vector that includes as its elements an average of 19 feature value moments, which are elements of the feature value vector. Further, “Λ” is a diagonal matrix of a reciprocal of a square root of an eigenvalue of a covariance matrix S calculated from a feature value vector and the average vector μ, and U is a matrix in which eigenvectors of the covariance matrix S are arranged.

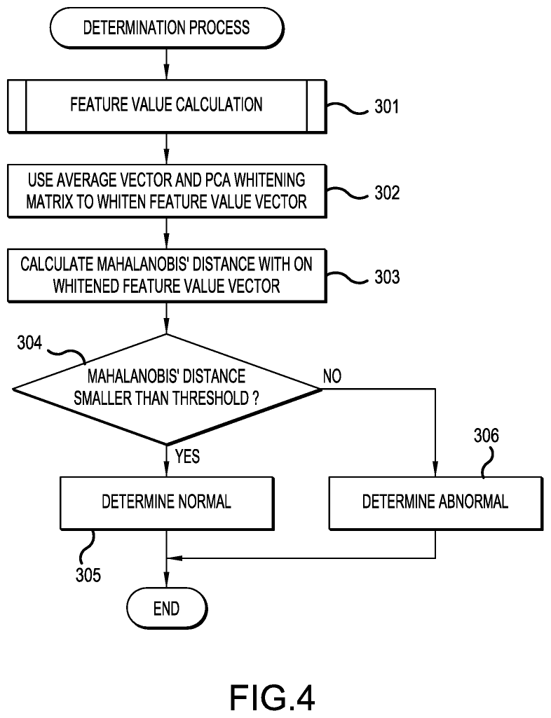

A process for determining abnormality of the monitored object in operation, which is performed after the preparation described above, is shown in FIG. 4. First, in step 301, a feature value vector is obtained by a feature value calculating process similar to that described above. Next, an average vector μ and a PCA whitening matrix ΛU obtained in the learning process are used to whiten the feature value vector by the formula (2) (step 302).

X′=ΛU(X−μ) (2)

In the formula, “X” is the feature value vector and “X′” is the whitened feature value vector.

Then, in step 303, a Mahalanobis' Distance MD is calculated with the formula (3) on the whitened feature value vector.

MD²=(X′−μ)^{T}R(X′−μ)

R=S⁻¹/n (3)

the formula, “n” is the number of dimensions of input data.

In step 304, if the calculated Mahalanobis' Distance MD is smaller than a predefined threshold, it is determined that the monitored object is operating normally (step 305), and if it is larger than the threshold, it is determined that the monitored object is operating abnormally (step 306). Then, the result is output, and the result can be used for various purposes, such as for controlling the operation of the monitored object and/or stopping the operation of the monitored object. By defining the threshold as appropriate, it is possible to detect (determine) an initiation of abnormality in the operation of the monitored object as “abnormality”. In the above, the threshold is appropriately determined from a set of Mahalanobis' Distances obtained by repeating step 301 to step 303 multiple times on monitored data during normal operation.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods and apparatuses for abnormality detection and machine control.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, is also understood as a corresponding method step or as a feature of a method step. In an analogous manner, aspects which have been described in the context of or as a method step also represent a description of a corresponding block or detail or feature of a corresponding device, such as the control unit.

As disclosed, the processing disclosed in the above embodiment is carried out by a personal computer having an internal microprocessor running a software program. Depending on certain implementation requirements, control may be implemented in various combinations of hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

Moreover, the hardware component that performs the methods disclosed above can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium, i.e., for the software program, can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the control unit, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

Therefore, although some aspects of the control unit have been identified as “parts” or “steps”, it is understood that such parts or steps need not be physically separate or distinct electrical components, but rather may be different blocks of program code that are executed by the same hardware component, e.g., one or more microprocessors.

What is claimed is:

1. A method, comprising:
acquiring time series monitored data from a monitored object;
calculating a wavelet transformed image from the monitored data;
calculating a feature value of the wavelet transformed image; and
determining a presence or an absence of an abnormality of the monitored object based on the feature value.

2. The method according to claim 1, wherein
the feature value is a moment from a predetermined origin on a wavelet transformed image.

3. The method, according to claim 1, wherein
the presence or the absence of the abnormality of the monitored object is determined based on a Mahalanobis' Distance calculated from the feature value.

4. The method, according to claim 2, wherein
the presence or the absence of the abnormality of the monitored object is determined based on a Mahalanobis' Distance calculated from the feature value.

5. The method according to claim 1, including stopping the operation of the monitored object in response to the determination of the presence of the abnormality of the monitored object.

6. The method according to claim 1, including automatically stopping the operation of the monitored object in response to the determination of the presence of the abnormality of the monitored object.

7. The method according to claim 6, wherein the monitored object is a machine tool mounted to a robot.

8. The method according to claim 7, wherein the monitored data comprises data obtained from at least one sensor selected from the group consisting of: vibration sensors, temperature sensors, accelerometers, sound sensors, voltage sensors, and position sensors.

9. An apparatus, comprising:
means of acquiring time series monitored data from a monitored object;
means of calculating a wavelet transformed image from the monitored data; and
means of calculating a feature value of the wavelet transformed image and determining a presence or an absence of an abnormality of the monitored object based on the feature value.

10. A method comprising:
acquiring time series monitored data from an operating machine tool mounted to a robot;
calculating a wavelet transformed image from the monitored data;
calculating a feature value of the wavelet transformed image;
determining a presence or an absence of an abnormality of the machine tool and/or the robot based on the feature value, and
in response to the determination of the presence of the abnormality, automatically stopping the operation of the robot and/or the machine tool.

11. The method according to claim 10, wherein the monitored data comprises data obtained from at least one sensor selected from the group consisting of: vibration sensors, temperature sensors, accelerometers, sound sensors, voltage sensors, and position sensors.
